(19) United States
(12) Patent Application Publication
(10) Pub. No.: US 2013/0323586 A1
(43) Pub. Date: Dec. 5, 2013

(54) MANUFACTURING METHOD OF ELECTRODE, AND BATTERY

(71) Applicant: Tomoyuki UEZONO, Toyota-shi (JP)

(72) Inventor: Tomoyuki UEZONO, Toyota-shi (JP)

(73) Assignee: TOYOTA JIDOSHA KABUSHIKI KAISHA, Toyota-shi (JP)

(21) Appl. No.: 13/903,021

(22) Filed: May 28, 2013

(30) Foreign Application Priority Data
May 31, 2012 (JP) 2012-125484

(51) Int. Cl. H01M 4/04; H01M 4/139; H01M 4/13

(52) U.S. Cl. CPC H01M 4/0404; H01M 4/13; H01M 4/139
USPC 429/211; 427/77

(57) ABSTRACT

An electrode includes a current collector formed in a sheet and an electrode mixture layer formed on the surface of a current collector. An electrode mixture containing an active material is prepared by using a kneading machine. The electrode mixture on a surface of the current collector is coated. The electrode mixture coated on the current collector is pressed to form the electrode mixture layer on the surface of the current collector. A first thickener and a second thickener are added to the active material when the electrode mixture is prepared. A 1% by weight aqueous solution of the first thickener has the viscosity of equal to or larger than 5000 and equal to or smaller than 9000 mPa·s. A 1% by weight aqueous solution of the second thickener has the viscosity of equal to or larger than 2000 and equal to or smaller than 5000 mPa·s.

### INCORPORATION BY REFERENCE

The disclosure of Japanese Patent Application No. 2012-125484 filed on May 31, 2012 including the specification, drawings and abstract is incorporated herein by reference in its entirety.

### BACKGROUND OF THE INVENTION

1. Field of the Invention

The invention relates to a manufacturing method of an electrode, and a battery, in particular, a technology for preparing an electrode mixture.

2. Description of Related Art

A battery (a lithium ion secondary battery, for example) having an electrode body that is obtained by winding a pair of electrodes (a positive electrode and a negative electrode) is broadly known. The pair of electrodes is formed in a sheet and stacked with a separator interposed therebetween.

An electrode of such the battery is prepared by coating an electrode mixture paste on a surface of a current collector sheet. In an electrode mixture containing a binder and a thickener, an aggregate may be formed. An electrode mixture in which an aggregate thereof is formed is difficult to uniformly coat on a surface of a current collector and may result in coating defects.

Japanese Patent Application Publication No. 2009-099441 (JP 2009-099441 A) discloses a technology according to which when an electrode mixture is prepared (in more detail, a negative electrode mixture), an aggregate can be suppressed from being formed by adding a high molecular weight thickener after adding a low molecular weight thickener. In JP 2009-099441 A, the viscosity of an aqueous solution of 1% by weight of a low molecular weight thickener is equal to or larger than 10 and equal to or smaller than 1800 mPa·s. Further, the viscosity of an aqueous solution of 1% by weight of a high molecular weight thickener is equal to or larger than 3000 and equal to or smaller than 10000 mPa·s.

However, when a solid content of an electrode mixture is increased, a low molecular weight thickener is absorbed to an active material contained in the electrode mixture. As a result, when a shearing force is applied to an electrode mixture, a phenomenon (dilatancy) in which the viscosity of the electrode mixture increases may occur and result in coating defects.

### SUMMARY OF THE INVENTION

The invention provides a technology that allows to efficiently coat an electrode mixture.

A first aspect of the invention relates to a manufacturing method of an electrode that includes a current collector and an electrode mixture layer formed on a surface of the current collector. The current collector is formed in a sheet. The manufacturing method includes preparing an electrode mixture containing an active material by using a kneading machine, coating the electrode mixture on the surface of the current collector, and pressing the electrode mixture coated on the current collector to form the electrode mixture layer on the surface of the current collector. When the electrode mixture is prepared, a first thickener and a second thickener are added to the active material. A 1% by weight aqueous solution of the first thickener has the viscosity of equal to or larger than 5000 and equal to or smaller than 9000 mPa·s. A 1% by weight aqueous solution of the second thickener has the viscosity of equal to or larger than 2000 and equal to or smaller than 5000 mPa·s.

A second aspect of the invention relates to a battery including an electrode manufactured by the manufacturing method according to the first aspect of the invention.

According to the first aspect and the second aspect of the invention, even when a solid content of an electrode mixture is increased, the electrode mixture can be efficiently coated.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 shows a manufacturing method of an electrode related to an embodiment of the invention; and

FIG. 2 shows a result of a final “overall determination” based on an evaluation of each of three items of “paste viscosity”, “filter penetration” and “the number of coating defects” of each of negative electrode mixtures of Examples 1 to 7 and Comparative Examples 1 to 3.

### DETAILED DESCRIPTION OF EMBODIMENTS

Hereinafter, a lithium ion secondary battery that is an embodiment of a battery related to the invention will be described.

The lithium ion secondary battery includes a case that is an outer package and an electrode body housed in the case.

The case is a container composed of aluminum or stainless steel. Inside the case, the electrode body and an electrolyte solution are housed together.

The electrode body is prepared by stacking a positive electrode and a negative electrode with a separator interposed therebetween and by winding their. The electrode body is impregnated with the electrolyte solution to function as a power generation element.

The positive electrode is an electrode that includes a sheet-like positive electrode current collector and a positive electrode mixture layer formed on a surface of the positive electrode current collector. The positive electrode current collector is a current collector constituted by a foil of a metal such as aluminum, titanium or stainless steel. The positive electrode mixture layer is an electrode mixture layer constituted by a positive electrode mixture containing a positive electrode active material, a conductive auxiliary agent and a binder.

The negative electrode is an electrode that includes a sheet-like negative electrode current collector and a negative electrode mixture layer formed on a surface of the negative electrode current collector. The negative electrode current collector is a current collector constituted by a foil of a metal such as copper, nickel or stainless steel. The negative electrode mixture layer is an electrode mixture layer constituted by a negative electrode mixture containing a negative electrode active material, a thickener and a binder.

The separator is an insulator constituted by a polyolefin resin (polyethylene, polypropylene, for example). The separator is interposed between the positive electrode and the negative electrode.

Hereinafter, the manufacturing step of the lithium ion secondary battery will be described.

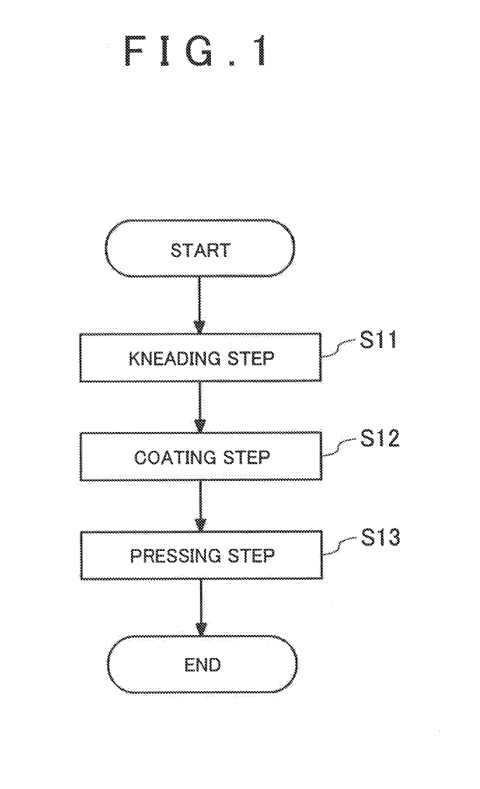

The manufacturing step of the lithium ion secondary battery includes the preparing step of the positive electrode, and the preparing step of the negative electrode. The preparing step of the negative electrode is shown in FIG. 1.

According to the preparing step of the positive electrode, firstly, by using a kneading machine such as a biaxial continuous kneading machine or a planetary mixer, the positive electrode active material is dispersed in a solvent together with a conductive auxiliary agent, a binder and the like to prepare a positive electrode mixture paste. Then, by using a coating machine such as a die coater, the positive electrode mixture is coated on a surface of the positive electrode current collector, and then dried. Finally, by applying a pressing process on the positive electrode mixture coated on a surface of the positive electrode current collector, the positive electrode mixture layer is formed on a surface of the positive electrode current collector.

The preparing step of a negative electrode is a method of manufacturing an electrode related to an embodiment of the invention. As shown in FIG. 1, the preparing step of a negative electrode includes the kneading step S11, the coating step S12 and the pressing step S13.

The kneading step S11 is a kneading step of predetermined materials to prepare the negative electrode mixture. In the kneading step S11, by using a kneading machine, the negative electrode active material is dispersed together with a thickener and a binder in a solvent (ion exchanged water, for example) to prepare the negative electrode mixture paste.

In the kneading step S11, as a thickener, a first thickener and a second thickener are used. The first thickener is a high-molecular weight thickener and the viscosity of a 1% by weight aqueous solution thereof is equal to or larger than 5000 and equal to or smaller than 9000 mPa·s. The second thickener is a thickener having a molecular weight smaller than that of the first thickener and the viscosity of a 1% by weight aqueous solution thereof is equal to or larger than 2000 and equal to or smaller than 5000 mPa·s.

In the kneading step S11, when these two kinds of thickeners are used, the following effect is exerted. Firstly, since the high viscosity first thickener is adsorbed to the negative electrode active material, even when a solid content of the negative electrode mixture is increased, a phenomenon (dilatancy) in which, when a shearing force is applied to the negative electrode mixture, the viscosity increases is suppressed from occurring. Secondly, since the low viscosity second thickener has high solubility in water and functions in a similar way to a surfactant between the negative electrode active material to which the first thickener is adsorbed and a solvent, the affinity of the negative electrode active material to a solvent is largely improved. Further, in a negative electrode mixture containing a negative electrode active material of which affinity toward the solvent is improved, air bubbles are not stabilized and immediately disappear during kneading. Accordingly, without performing the defoaming step, likelihood that air bubbles remain in the negative electrode mixture is reduced.

As the first thickener and the second thickener, cellulose ether (for example, carboxy methylcellulose, methylcellulose) and polyether (for example, polyethylene oxide, polyacrylamide) may be adopted. In particular, from the viewpoint of having high affinity with water and high affinity also with the negative electrode active material, carboxy methylcellulose (CMC) is preferably adopted as the first thickener and the second thickener.

Further, in the kneading step S11, the first thickener and the second thickener are preferably charged in a kneading machine in a state of powder (in a state not dissolved in a solvent). This is because a time and equipment necessary for separately preparing an aqueous solution containing the first thickener and the second thickener can be omitted. In particular, when the viscosity of a thickener is large, a time necessary for dissolving becomes longer and an operation of taking out the aqueous solution becomes troublesome. Accordingly, by charging the first thickener and the second thickener in a kneading machine in a state of powder, a time and a cost necessary for preparing the negative electrode mixture can be reduced.

Further, as a kneading machine used in the kneading step S11, a biaxial continuous kneading machine is preferably adopted. The biaxial continuous kneading machine is a kneading machine that includes a hollow barrel that forms an outer package, two rotary shafts disposed inside the barrel in parallel to each other, and a plurality of paddles. The plurality of paddles is disposed to the rotary shafts and kneads materials charged inside of the barrel. The biaxial continuous kneading machine is different from a kneading machine such as a planetary mixer in that the biaxial continuous kneading machine has an advantage that there is no need of an operation of scraping materials off a blade for kneading the materials during kneading the materials. In general, it is structurally difficult, with the biaxial continuous kneader, to knead a material while depressurizing. Accordingly, a paste prepared with the biaxial continuous kneading machine may contain residual air bubbles. Therefore, when a biaxial continuous kneading machine is used in the preparing step of an electrode mixture of a battery, there is a possibility that air bubbles remain in the electrode mixture to deteriorate performance of a battery. Thus, since it is necessary to separately carry out an operation for removing air bubbles in the electrode mixture, a time and a cost necessary for preparing the negative electrode mixture may increase. However, as was described above, in the kneading step S11, by using the first thickener and the second thickener, air bubbles are suppressed from remaining in the negative electrode mixture. Accordingly, in the kneading step S11, even when a biaxial continuous kneading machine is used, without remaining air bubbles in the negative electrode mixture, such the advantage of the biaxial continuous kneading machine can be exerted. As a kneading machine used in the kneading step S11, a biaxial continuous kneading machine disclosed in JP 2011-224435 A may be adopted.

The coating step S12 is a coating step of the negative electrode mixture on a surface of the negative electrode current collector. In the coating step S12, by using a coater such as a die coater, the negative electrode mixture is coated on a surface of the negative electrode current collector. As was described above, by using the first thickener and the second thickener in the kneading step S11, in the negative electrode mixture, the dilatancy and residual air bubbles are suppressed from occurring. As a result, in the coating step S12, the negative electrode mixture is sufficiently coated on a surface of the negative electrode current collector. Accordingly, the possibility is reduced that a performance of a lithium ion secondary battery that is finally prepared is deteriorated.

In the coating step S12, after the negative electrode mixture is coated on a surface of the negative electrode current collector, the negative electrode mixture is dried with a drying furnace. As was described above, since the first thickener and the second thickener are used in the kneading step S11, the possibility is reduced that the dilatancy occurs when a solid content of the negative electrode mixture is increased. As a result of increasing a solid content of the negative electrode mixture, the negative electrode mixture can be dried in a short time. Accordingly, a length of a drying furnace for drying the negative electrode mixture can be shortened, and a time and a cost necessary for preparing the negative electrode can be reduced.

The pressing step S13 is a pressing step of a negative electrode mixture coated on the negative electrode current collector. In the pressing step S13, by pressing a negative electrode mixture coated on the negative electrode current collector with a roller press, the negative electrode mixture layer is formed on a surface of the negative electrode current collector.

As was described above, in the preparing step of a negative electrode, via the kneading step S11, the coating step S12 and the pressing step S13 sequentially, the negative electrode is prepared. After the preparing step of a positive electrode and the preparing step of a negative electrode, via the preparing step of the electrode body with the positive electrode and the negative electrode, the housing step of the electrode body in the case, and the injecting step of the electrolyte solution inside the case where the electrode body was housed, the lithium ion secondary battery is manufactured. In the embodiment, by using the first thickener and the second thickener, the negative electrode is prepared as described above (the preparing step of a negative electrode). On the other hand, in a manner similar to that of the negative electrode, by using the first thickener and the second thickener, the positive electrode may be prepared. In this case, in the preparing step a positive electrode for preparing the positive electrode, it is possible to obtain the same effect as that obtained in the case where the negative electrode is prepared in the preparing step of a negative electrode.

Hereinafter, based on Examples 1 to 7 and Comparative Examples 1 to 3, performance of a negative electrode mixture used in a negative electrode related to an embodiment of the invention will be described.

A negative electrode mixture of Example 1 was prepared as shown below. As a first thickener, CELOGEN® BSH-12 that is carboxy methylcellulose (CMC), manufactured by Daiichi Kogyo Seiyaku Co. (the viscosity of 1% by weight aqueous solution: equal to or larger than 6000 and equal to or smaller than 8000 mPa·s (25° C.), degree of etherification: equal to or larger than 0.65 and equal to or smaller than 0.75) was adopted. As a second thickener, CELOGEN® BSH-6 that is carboxy methylcellulose (CMC), manufactured by Daiichi Kogyo Seiyaku Co. (the viscosity of 1% by weight aqueous solution: equal to or larger than 3000 and equal to or smaller than 4000 mPa·s (25° C.), degree of etherification: equal to or larger than 0.60 and equal to or smaller than 0.70) was adopted. Further, as a negative electrode active material, amorphous coat graphite was adopted, and, as a binder, BM-400B that is styrene-butadiene rubber (SBR), manufactured by Nippon Zeon Co., was adopted. As a solvent, ion-exchanged water was adopted. Then, by using a biaxial continuous kneading machine, the negative electrode active material was dispersed in a solvent, thereby, a negative electrode mixture having a solid content rate of 54% was prepared. The negative electrode mixture was prepared to have a ratio of: first thickener: second thickener: binder of 98.3:0.65:0.05:1.0 (% by weight).

A negative electrode mixture of Example 2 was prepared in a same manner as that of Example 1 except that an addition amount of a first thickener was set to 0.60% by weight and an addition amount of a second thickener was set to 0.10% by weight.

A negative electrode mixture of Example 3 was prepared in a same manner as that of Example 1 except that an addition amount of a first thickener was set to 0.50% by weight and an addition amount of a second thickener was set to 0.20% by weight.

A negative electrode mixture of Example 4 was prepared in a same manner as that of Example 1 except that an addition amount of a first thickener was set to 0.40% by weight and an addition amount of a second thickener was set to 0.30% by weight.

A negative electrode mixture of Example 5 was prepared in a same manner as that of Example 1 except that an addition amount of a first thickener was set to 0.30% by weight and an addition amount of a second thickener was set to 0.40% by weight.

A negative electrode mixture of Example 6 was prepared in a same manner as that of Example 1 except that an addition amount of a first thickener was set to 0.20% by weight and an addition amount of a second thickener was set to 0.50% by weight.

A negative electrode mixture of Example 7 was prepared in a same manner as that of Example 1 except that an addition amount of a first thickener was set to 0.10% by weight and an addition amount of a second thickener was set to 0.60% by weight.

In a negative electrode mixture according to Comparative Example 1, without using a first thickener and a second thickener, the BSH-12 was adopted as a thickener. A negative electrode mixture of Comparative Example 1 was prepared in a manner the same as that of Example 1 except that an addition amount of the thickener was set to 0.70% by weight.

In a negative electrode mixture according to Comparative Example 2, without using a first thickener and a second thickener, the BSH-6 was adopted as a thickener. A negative electrode mixture of Comparative Example 2 was prepared in a same manner as that of Example 1 except that an addition amount of the thickener was set to 0.70% by weight.

In a negative electrode mixture according to Comparative Example 3 CELOGEN® WS-CN that is carboxy methylcellulose (CMC), manufactured by Daiichi Kogyo Seiyaku Co. (the viscosity of 1% by weight aqueous solution: equal to or larger than 110 and equal to or smaller than 150 mPa·s (25° C.), degree of etherification: equal to or larger than 0.60 and equal to or smaller than 0.70) was adopted as a first thickener, and the BSH-12 was adopted as a second thickener. A negative electrode mixture of Comparative Example 3 was prepared in a same manner as that of Example 1 except that an addition amount of each of a first thickener and a second thickener was set to 0.35% by weight.

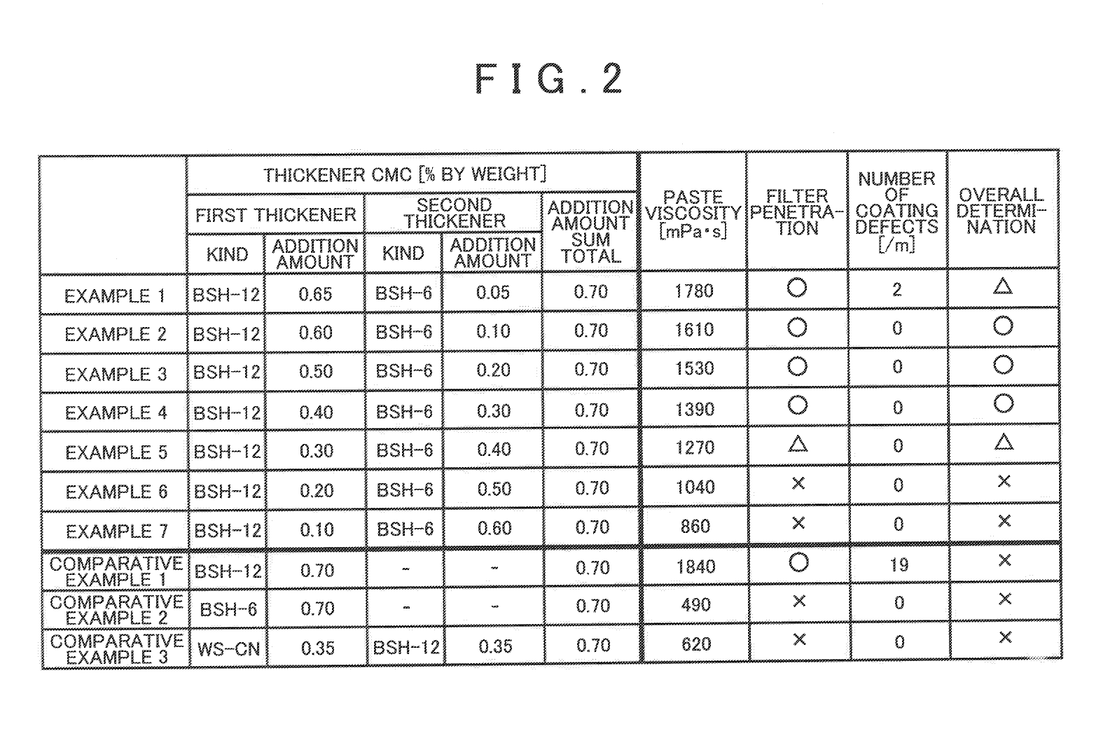

FIG. 2 shows a result of a final “overall determination” based on an evaluation of each of three items of “paste viscosity”, “filter penetration” and “the number of coating defects” of each of negative electrode mixtures of Examples 1 to 7 and Comparative Examples 1 to 3. Here, the “paste viscosity” is the viscosity of a negative electrode mixture and desirable to be equal to or larger than 1000 mPa·s and equal to or smaller than 2000 mPa·s. When the “paste viscosity” is smaller than 1000 mPa·s, a negative electrode active material in the negative electrode mixture may precipitate. When the “paste viscosity” is larger than 2000 mPa·s, it is difficult to coat the negative electrode mixture with a coating machine. The “filter penetration” is an item for inspecting whether the negative electrode mixture passes through a filter (STF50, manufactured by ROKI Techno Co., Ltd.) or not to evaluate whether the dilatancy is caused or not of the negative electrode mixture. In FIG. 2, a “circle” in the “filter penetration” means that a negative electrode mixture sufficiently passes through a filter. In the “filter penetration”, “a delta” means that a negative electrode mixture is difficult to pass through a filter than the “circle”. In the “filter penetration”, a “cross” means that a negative electrode mixture does not utterly pass through a filter. “The number of coating defects” means the number of coating defects a meter (in a longer direction) in a negative electrode mixture coated on a negative electrode current collector and is desirable to be less than two. As the number of coating defects becomes larger, the material yield and the battery performance are more deteriorated. A “circle” in the “overall determination” means that a negative electrode mixture has satisfactory performance. A “delta” in the “overall determination” means that performance of a negative electrode mixture is inferior to the performance of a negative electrode mixture of which “overall determination” is the “circle” but has desired performance. Hereinafter, in some cases, the “delta” in the “overall determination” means that a negative electrode mixture has substantially sufficient performance. A “cross” in the “overall determination” means that a negative electrode mixture does not have a desired performance.

In Example 1, although the “paste viscosity” was equal to or larger than 1000 mPa·s and equal to or smaller than 2000 mPa·s (1780 mPa·s) and the “filter penetration” was sufficient, “the number of coating defects” was two. This is considered that since an addition amount of the low viscosity second thickener was a little scarce, a small amount of air bubbles remained in a negative electrode mixture. As was described above, although the “number of coating defects” is desirable to be less than two, when the “number of coating defects” is two, there is no large problem; accordingly, as an “overall determination” of Example 1, the prepared negative electrode mixture was determined as having substantially sufficient properties.

In Example 2, the “paste viscosity” was equal to or larger than 1000 mPa·s and equal to or smaller than 2000 mPa·s (1610 mPa·s), the “filter penetration” was sufficient, and the “number of coating defects” was zero, that is, desirable evaluation results were obtained of all items. Accordingly, as an “overall determination” of Example 2, the prepared negative electrode mixture was determined as having sufficient properties.

In Example 3, the “paste viscosity” was equal to or larger than 1000 mPa·s and equal to or smaller than 2000 mPa·s (1530 mPa·s), the “filter penetration” was sufficient, and the “number of coating defects” was zero, that is, desirable evaluation results were obtained of all items. Accordingly, as an “overall determination” of Example 3, the prepared negative electrode mixture was determined as having sufficient properties.

In Example 4, the “paste viscosity” was equal to or larger than 1000 mPa·s and equal to or smaller than 2000 mPa·s (1390 mPa·s), the “filter penetration” was sufficient, and the “number of coating defects” was zero, that is, desirable evaluation results were obtained of all items. Accordingly, as an “overall determination” of Example 4, the prepared negative electrode mixture was determined as having sufficient properties.

In Example 5, the “paste viscosity” was equal to or larger than 1000 mPa·s and equal to or smaller than 2000 mPa·s (1270 mPa·s) and the “number of coating defects” was zero. However, the “filter penetration” was not desirable compared with that of Examples 1 to 4. This is considered that since an addition amount of the high viscosity first thickener is scarce than that of Examples 1 to 4, the dilatancy was generated of a negative electrode mixture. However, since the negative electrode mixture slightly passed through a filter, as an “overall determination” of Example 5, the prepared negative electrode mixture was determined as having substantially sufficient properties.

In Example 6, although the “paste viscosity” was equal to or larger than 1000 mPa·s and equal to or smaller than 2000 mPa·s (1040 mPa·s) and the “number of coating defects” was zero, the “filter penetration” was evaluated as undesirable. This is considered that since an addition amount of the high viscosity first thickener is scarce, the dilatancy was generated of a negative electrode mixture. Accordingly, as an “overall determination” of Example 6, the prepared negative electrode mixture was determined as not having desirable properties.

In Example 7, although the “number of coating defects” was zero, the “paste viscosity” was smaller than 1000 mPa·s (860 mPa·s) and also the “filter penetration” was evaluated as undesirable. This is considered that since an addition amount of the high viscosity first thickener was scarce to result in insufficient viscosity of a negative electrode mixture, the dilatancy was caused of a negative electrode mixture. Accordingly, as an “overall determination” of Example 7, the prepared negative electrode mixture was determined as not having desirable properties.

In Comparative Example 1, although the “paste viscosity” was equal to or larger than 1000 mPa·s and equal to or smaller than 2000 mPa·s (1840 mPa·s) and the “filter penetration” was sufficient, the “number of coating defects” was 19. This is considered that since only the high viscosity thickener was added, an abundant amount of air bubbles remained in a negative electrode mixture. Accordingly, as an “overall determination” of Comparative Example 1, the prepared negative electrode mixture was determined as not having desired properties.

In Comparative Example 2, although the “number of coating defects” was zero, the “paste viscosity” was smaller than 1000 mPa·s (490 mPa·s) and also the “filter penetration” was evaluated as undesirable. This is considered that since only the low viscosity thickener was added, the dilatancy was caused of the negative electrode mixture. Accordingly, as an “overall determination” of Comparative Example 2, the prepared negative electrode mixture was determined as not having desired properties.

In Comparative Example 3, although the “number of coating defects” was zero, the “paste viscosity” was smaller than 1000 mPa·s (620 mPa·s) and also the “filter penetration” was evaluated as undesirable. This is considered that since a first thickener having a molecular weight largely smaller than that of other examples adsorbs a negative electrode active material, the dilatancy was caused of the negative electrode mixture. Further, by adding a first thickener having a molecular weight largely smaller than that of other examples, the viscosity of the negative electrode mixture becomes deficient and the negative electrode mixture precipitated. Accordingly, as an “overall determination” of Comparative Example 3, the prepared negative electrode mixture was determined as not having desired properties.

As shown in Examples 1 to 5, it was found that a negative electrode mixture used in a negative electrode related to an embodiment of the invention shows sufficient properties when a first thickener and a second thickener are added in the solid content thereof at a weight ratio of 3:4 to 13:1. Furthermore, as shown in Examples 2 to 4, it was found that the negative electrode mixture used in the negative electrode related to the embodiment of the invention shows more sufficient properties when a first thickener and a second thickener are added in the solid content thereof at a weight ratio of 4:3 to 6:1 than when the first thickener and the second thickener are added in the solid content thereof at the weight ratio of 3:4 to 13:1. In particular, it was found that a negative electrode mixture used in a negative electrode related to an embodiment of the invention has sufficient properties also when a solid content rate is high (54%).

What is claimed is:

1. A manufacturing method of an electrode that includes a current collector formed in a sheet and an electrode mixture layer formed on a surface of the current collector, the manufacturing method comprising:
preparing an electrode mixture containing an active material by using a kneading machine;
coating the electrode mixture on a surface of the current collector; and
pressing the electrode mixture coated on the current collector to form the electrode mixture layer on the surface of the current collector,
wherein: when the electrode mixture is prepared, a first thickener and a second thickener are added to the active material;
a 1% by weight aqueous solution of the first thickener has the viscosity of equal to or larger than 5000 and equal to or smaller than 9000 mPa·s; and
a 1% by weight aqueous solution of the second thickener has the viscosity of equal to or larger than 2000 and equal to or smaller than 5000 mPa·s.

2. The manufacturing method according to claim 1, wherein
the electrode is a negative electrode.

3. The manufacturing method according to claim 1, wherein
the kneading machine is a biaxial continuous kneading machine.

4. The manufacturing method according to claim 1, wherein
a weight ratio between the first thickener and the second thickener in a solid content of the electrode mixture is 3:4 to 13:1.

5. The manufacturing method according to claim 4, wherein
the weight ratio between the first thickener and the second thickener in the solid content of the electrode mixture is 4:3 to 6:1.

6. The manufacturing method according to claim 1, wherein
both the first thickener and the second thickener are carboxy methylcellulose.

7. The manufacturing method according to claim 1, wherein
when the electrode mixture is prepared, the first thickener and the second thickener are charged in the kneading machine in a state of powder.

8. The manufacturing method according to claim 1, wherein
a solid content rate of the electrode mixture is 54%.

9. The manufacturing method according to claim 1, wherein
a viscosity of the electrode mixture is equal to or larger than 1000 mPa·s and equal to or smaller than 2000 mPa·s.

10. A battery including an electrode manufactured by the manufacturing method according to claim 1.
